(19) United States
(12) Patent Application Publication
(10) Pub. No.: US 2009/0232252 A1
(43) Pub. Date: Sep. 17, 2009

(54) Method and Apparatus for Digital Encoding with Reduced Memory Requirement and Complexity

(76) Inventors: Dukhyun Kim, Marietta, GA (US); Jin-Youn Cho, Alpharetta, GA (US)

Correspondence Address: SUTHERLAND ASBILL & BRENNAN LLP, 999 PEACHTREE STREET, N.E., ATLANTA, GA, 30309, US

(21) Appl. No.: 12/048,524

(22) Filed: Mar. 14, 2008

(51) Int. Cl. H04L 27/36; H04L 27/00

(52) U.S. Cl. 375/298; 375/295

(57) ABSTRACT

Systems and methods may be provided for supporting encoding of digital communications, including space time block encoding (STBC). Example systems and methods may include receiving at least one input bit, wherein the at least one input bit is associated with a mapping on a Gray-coded constellation map, storing the received at least one input bit in one or more memory locations, retrieving the at least one bit from the one or more memory locations, inverting a bit of the at least one bit to generate a conjugate of the at least one bit, and obtaining first coordinates of the conjugate according to the Gray-coded constellation map.

### FIELD OF THE INVENTION

Embodiments of the present invention relate to encoding in digital communication systems and devices.

### BACKGROUND OF INVENTION

Space Time Block Coding (STBC) is a special form of channel coding scheme used in wireless communication systems. The STBC provides antenna diversity gain and hence makes it possible to maintain communication link at longer range between the transmitter and the receiver. With STBC, multiple antennas are required only at the transmitter while the receiver is not required to have multiple antennas. Since the STBC encoding is performed over space and time, additional memory needs to be used during the encoding process. Straightforward implementation of the STBC encoding requires mathematical operation such as complex conjugate and negative complex conjugate of digitally modulated symbols such as Binary Phase Shift Keying (BPSK), Quadrature Phase Shift Keying (QPSK), 16-Quadrature Amplitude Modulation (16-QAM) or 64-Quadrature Amplitude Modulation (64-QAM) and so on.

Orthogonal Frequency Division Multiplexing (OFDM) is a special form of multi-carrier modulation which carries digitally modulated symbols over many subcarriers. The OFDM combined with BPSK, QPSK, QPSK, and M-QAM symbols have been used in a large number of modern communications systems and standards to deliver high data-rate information of wireless channels. The STBC can and has been included within the OFDM-based systems such as IEEE 802.11n Physical Layer specifications as optional coding scheme. Since the OFDM transmits a vector of symbols rather than one symbol at a time, required memory size with the STBC increases proportional to the length of the vector used for the OFDM modulation. Therefore, reducing memory usage is a significant issue with an STBC implementation.

### SUMMARY OF THE INVENTION

In an example method and apparatus according to an example embodiment of the invention, an encoding may be performed in a way to reduce required memory size. For certain mathematical operations, simple bit inversion may be performed instead of direct application of the mathematical operations. When Space Time Block Coding (STBC) with Gray-coded Quadrature Amplitude Modulation (QAM) is considered, complex conjugate and negative complex conjugate operations may be replaced by a single bit inversion, thereby significantly reducing the required memory size.

According to an example embodiment of the invention, there may be a method for supporting encoding of digital communications. The method may include receiving at least one input bit, wherein the at least one input bit is associated with a mapping on a Gray-coded constellation map, storing the received at least one input bit in one or more memory locations, and retrieving the at least one bit from the one or more memory locations. The method may also include inverting a bit of the at least one bit to generate a conjugate of the at least one bit and obtaining first coordinates of the conjugate according to the Gray-coded constellation map.

According to another example embodiment of the invention, there may be a system for supporting encoding of digital communications. The system may include at least one input bit, where the at least one input bit is associated with a mapping on a Gray-coded constellation map, a write module for storing the at least one bit in one or more memory locations, and a read module for retrieving the at least one bit from the one or more memory locations. The system may also include a bit inverter module that inverts a bit of the at least one bit to generate a conjugate of the at least one bit, and a mapping module that obtains first coordinates of the conjugate according to the Gray-coded constellation map.

### BRIEF DESCRIPTION OF THE DRAWINGS

Having thus described the invention in general terms, reference will now be made to the accompanying drawings, which are not necessarily drawn to scale, and wherein:

FIG. 1A illustrates an example reflect-and-prefix method for constructing reflected binary code or Gray-coded bits, according to an example embodiment of the invention.

FIG. 1B illustrates an example 64-QAM (quadrature amplitude modulation) constellation map that may be constructed in accordance with a reflect-and-prefix method, according to an example embodiment of the invention.

FIGS. 1C-1E illustrate alternative example constellation maps that may be constructed in accordance with a reflect-and-prefix method, according to an example embodiment of the invention.

FIG. 2 illustrates an example pre-mapping STBC encoder in accordance with an example embodiment of the invention.

FIGS. 3-6 illustrate example pre-mapping STBC encoding operations for the STBC encoding options as described in a IEEE 802.11n Draft 2.0 specification, according to an example embodiment of the invention.

### DETAILED DESCRIPTION OF THE INVENTION

Example embodiments of the invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Example embodiments of the invention may provide for reduced memory and/or reduced operational/hardware requirements for Space Time Block Coding (STBC) in communications systems. For example, embodiments of the invention may provide for a pre-mapping STBC encoder. A pre-mapping STBC encoder in accordance with an example embodiment of the invention may be operative to receive input bits that are associated with one or more symbols mapped on a Gray-coded constellation map. The STBC encoder may store the received input bits in one or more memory locations. Likewise, the STBC encoder may retrieve previously stored input bits from one or more memory locations. The number of memory locations utilized by an STBC encoder may depend on the number of space time streams (N_{STS}) and spatial streams (N_{SS}), according to an example embodiment of the invention. Once the STBC encoder retrieves the input bits, the STBC encoder may apply bit-inversion to one or more of the retrieved input bits to generate one or more conjugates, including complex conjugates or negative complex conjugates that may be utilized for STBC encoding. The STBC encoder may then obtain coordinates of the input bits and the one or more conjugates, where the coordinates correspond to the Gray-coded constellation map, according to an example embodiment for the invention.

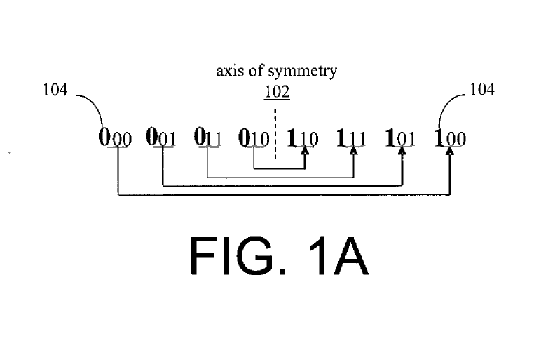

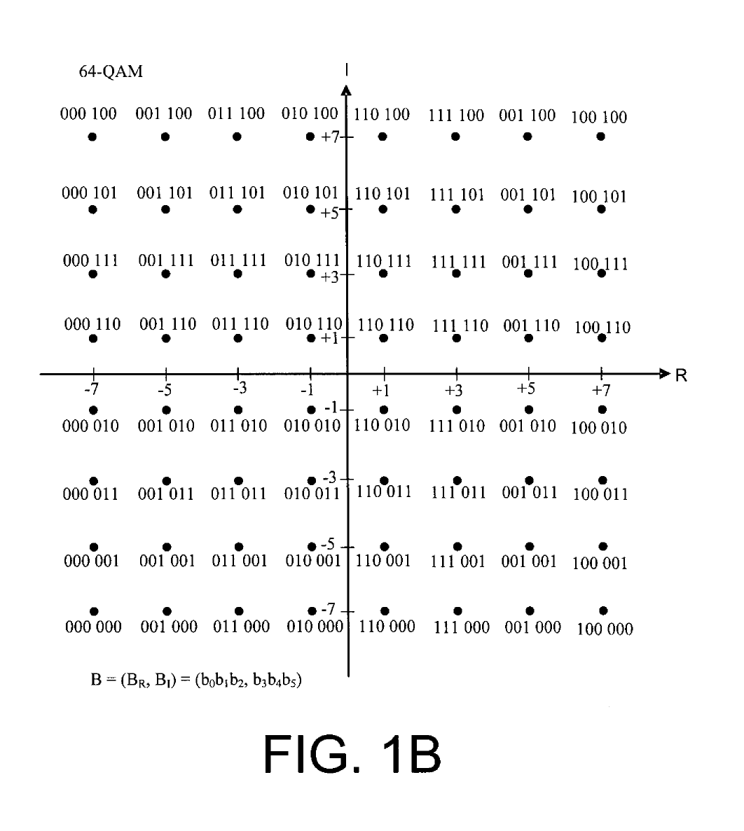

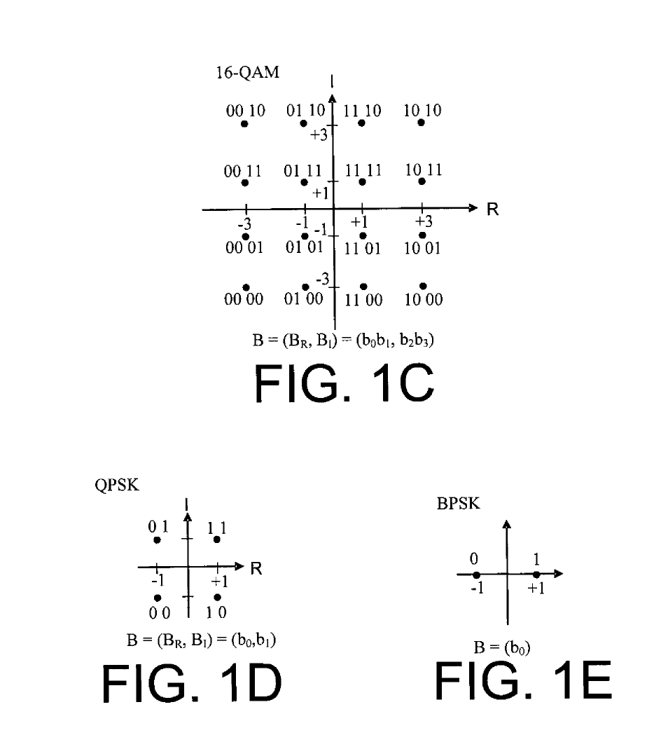

FIG. 1A illustrates an example reflect-and-prefix method for constructing reflected binary code or Gray-coded bits, according to an example embodiment of the invention. In FIG. 1A, each successive set of encoded bits may vary by a single bit. FIG. 1A also illustrates an example axis of symmetry 102. As shown in FIG. 1A, when the encoded bits are reflected symmetrically across the axis of symmetry 102, only the prefix bit 104 for each set of encoded bits may be different. By utilizing a reflect-and-prefix method as in FIG. 1A, encoded bits corresponding to any mapped symbol (e.g., a point) in a constellation may differ from the encoded bits corresponding to its reflected symbol in one or more axes (e.g., a real axis, an imaginary axis, etc.) by one bit such as at the prefix bit position or another bit position.

FIG. 1B illustrates an example 64-QAM (quadrature amplitude modulation) constellation map that may be constructed in accordance with a reflect-and-prefix method, according to an example embodiment of the invention. As shown in FIG. 1B, the example 64-QAM constellation map may include a first axis such as a real axis (R) and a second axis such a an imaginary axis (I). Alternatively, it will also be appreciated that the first axis and the second axis may be referred to as respective I and Q axes, according to another example embodiment of the invention. The 64-QAM constellation map may include a representation of 64 symbols, according to an example embodiment of the invention. Gray encoded bits in the form of one or more sets of real bits B_{R} and imaginary bits B_{I} may be mapped to symbols on the constellation map, according to an example embodiment of the invention. For example, the Gray encoded bits of (B_{R}=100, B_{I}=100) may correspond to a symbol having coordinates of (+7, +7) on a 64-QAM constellation map. In FIG. 1B, the complex conjugate of the symbol at coordinates of (+7, +7) may be located at coordinates of (+7, −7), which are associated with Gray encoded bits of (B_{R}=100, B_{I}=000). On the other hand, the negative complex conjugate of the symbol at coordinates of (+7, +7) may be located at coordinates of (−7, +7), which are associated with the Gray encoded bits of (B_{R}=000, B_{I}=100). With either conjugate, it will be appreciated that the Gray encoded bits B_{R}, B_{I} for a symbol and its associated conjugate may differ by only one bit, as illustrated herein. It should also be appreciated that when Gray encoding is utilized for bits B_{R} and B_{I} (corresponding to the respective first and second axes), encoded bits corresponding to any mapped symbol in the constellation may differ from the encoded bits corresponding to any of its closest neighboring symbols by one bit.

FIGS. 1C-1E illustrate alternative example constellation maps that may be constructed in accordance with a reflect-and-prefix method, according to an example embodiment of the invention. FIG. 1C illustrates an example 16-QAM constellation map having 16 example symbols, according to an example embodiment of the invention. As shown in FIG. 1C, only two bits may be necessary for each set of Gray coded bits B_{R}, B_{I} to represent the 16 example symbols in the example 16-QAM constellation map. FIG. 1D illustrates a Quadrature Phase Shift Keying (QPSK) constellation map having 4 example symbols, according to an example embodiment of the invention. As shown in FIG. 1D, only one bit may be necessary for each set of Gray coded bits B_{R}, B_{I} to represent the 4 example symbols in the example QPSK constellation map. FIG. 1E illustrates an example Binary Phase Shift Keying (BPSK) constellation map having two example symbols, according to an example embodiment of the invention. As shown in FIG. 1E, only one Gray encoded bit b₀ may be needed to represent the two example symbols in the example BPSK constellation map. It will be appreciated that while some example modulation schemes and associated constellation maps have been presented for illustrative purposes, other example constellation maps may likewise may be utilized, including other QAM constellation maps (e.g., 256-QAM, 1024-QAM).

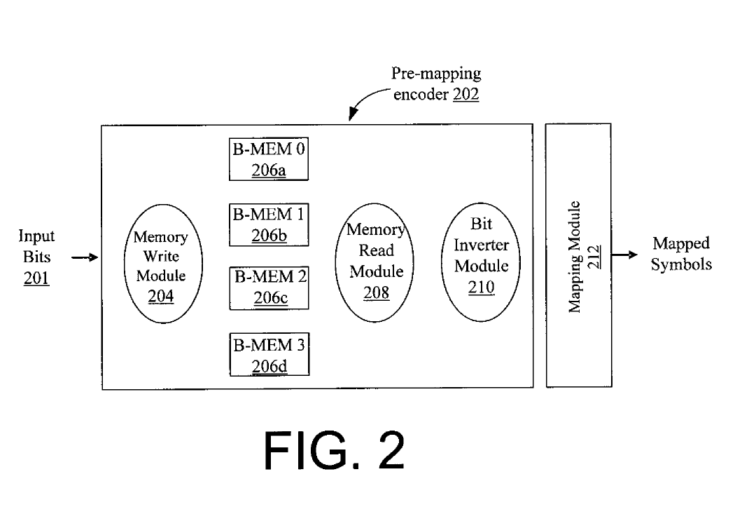

FIG. 2 illustrates an example pre-mapping STBC encoder in accordance with an example embodiment of the invention. In FIG. 2, there may be input bits 201 received by a pre-mapping encoder 202. An output of the pre-mapping encoder 202 may be provided to a mapping module 212 that provides one or more coordinates described herein for use in STBC encoding. The input bits 201 may include one or more coded input bits such as Forward Error Correction (FEC) coded bits. These input bits 201 may be associated with one or more symbols on a Gray-coded constellation map, according to an example embodiment of the invention. In some example embodiments of the invention, these input bits 201 may be received from an interleaver (not shown). The interleaver may be operative to protect a transmission from errors such as burst errors, according to an example embodiment of the invention.

The pre-mapping encoder 202 may include a memory write module 204, one or more memory locations 206a-d (or buffers), a memory read module 208, and a bit inverter module 210. During operation of the pre-mapping encoder 202, the memory write module 204 may store the received input bits 201 in one or more memory locations 206a-d. Likewise, the memory read module 208 may retrieve one or more previously stored input bits 201 from the other memory locations 206a-d. In an example embodiment of the invention, the number of necessary memory locations 206a-d may be determined according to the number of space time streams (N_{STS}) and number of spatial streams (N_{SS}) utilized for the STBC encoding. After the input bits 201 are obtained by the memory read module 208, the bit inverter module 210 may perform complex conjugate and/or negative complex conjugate operations on the retrieved input bits 201.

In an example embodiment of the invention, the bit inverter module 210 may perform complex conjugate operation on the input bits 201 (e.g., B_{R}, B_{I}) by inverting a bit in the imaginary bits B_{I}. On the other hand, the bit inverter module 210 may perform a negative complex conjugate operation on the input bits 201 by inverting a bit in the real bits B_{R}. For example, assume that the input bits 201 include bits B_{R}, B_{I} that corresponds to symbol S, which is comprised of S=S_{R}+jS_{I}, where S_{R} is a coordinate component on the real axis that B_{R} bits are mapped to, and S_{I} is a coordinate component on the imaginary axis that B_{I} bits are mapped to. The complex conjugate S* of symbol S may be defined as S*=S_{R}−jS_{I}, according to an example embodiment of the invention. Likewise, the negative complex conjugate −S* of symbol S may be defined as −S*=−S_{R}+jS_{I}. Accordingly, since bit inverter module 210 operates on input bits 201 (e.g., B_{R}, B_{I}), the bit inverter module 210 may perform a complex conjugate operation by inverting a prefix bit or another bit of the imaginary bit B_{I} to generate bits B¹_{I}. Likewise, the bit inverter module 210 may perform a negative complex conjugate operation by inverting a prefix bit or another bit of the real bits B_{R} to generate bits B¹_{R}. In an example embodiment of the invention, the complex conjugate operations of the bit inverter module may be summarized as follows:
S*=S_{R}+jS¹_{I} where S_{R}=Map(B_{R}), S¹_{I}=Map(B¹_{I}) and
−S*=S¹_{R}+jS_{I} where S¹_{R}=Map(B¹_{R}), S_{I}=Map(B_{I}), where B¹_{R} is equal to B_{R} with its prefix bit logically inverted and B¹_{I} is equal to B_{I} with its prefix bit logically inverted.

It will be appreciated that while embodiments of the invention may illustrate inversion of a prefix bit for a conjugate operation, other embodiments may utilize inversion other bit positions as well. For example, another bit position may include a fixed bit position such as a center bit position or suffix bit position. According to an example embodiment of the invention, one may reorder the encoded bits in each axis and satisfy the requirements of Gray coded mapping while still preserving the principle of a bit inversion to accomplish one or more conjugate operations described herein.

Still referring to FIG. 2, the mapping module 212 may be operative to receive a plurality of output bits from the pre-mapping encoder 202. Example output bits may include the input bits 201 (e.g., B_{R} and B_{I}) retrieved by the memory read module 208. Using these input bits 20 1, the mapping module 212 may determine the input symbol coordinates (e.g., real coordinates) of the on a constellation map. Additionally, the output (e.g., B_{R} and B¹_{I}) of the complex conjugate operation by the bit inverter module 210 may likewise be provided to the mapping module 212 to determine the complex conjugate symbol coordinates on the constellation map. Similarly, the output (e.g., B¹_{R} and B_{I}) of the negative complex conjugate operation by the bit inverter module 210 may likewise be provided to the mapping module 212 to determine the negative complex conjugate symbol coordinates on the constellation map. It will be appreciated that while FIG. 2 illustrates only a single bit inverter module 210, other example embodiments of the invention may include a plurality of bit inverter modules 210 without departing from example embodiments of the invention. For example, one bit inverter module may be utilized for complex conjugate operations while another bits inverter module may be utilized for negative complex conjugate operations, according to an example embodiment of the invention. It will also be recognized that the bit inverter module 210 may perform complex conjugate and negative complex conjugate operations before the mapping module 212. Such a pre-mapping module operation may provide an advantage since the number of bits that represent an input to the mapping module 212 may be less (e.g., oftentimes significantly less) than the number of bits that represent corresponding mapped-symbol output of the mapping module 212 (e.g., a real number). Therefore, the required memory buffer size utilized for memory locations 206a-d may likewise be reduced, according to an example embodiment of the invention.

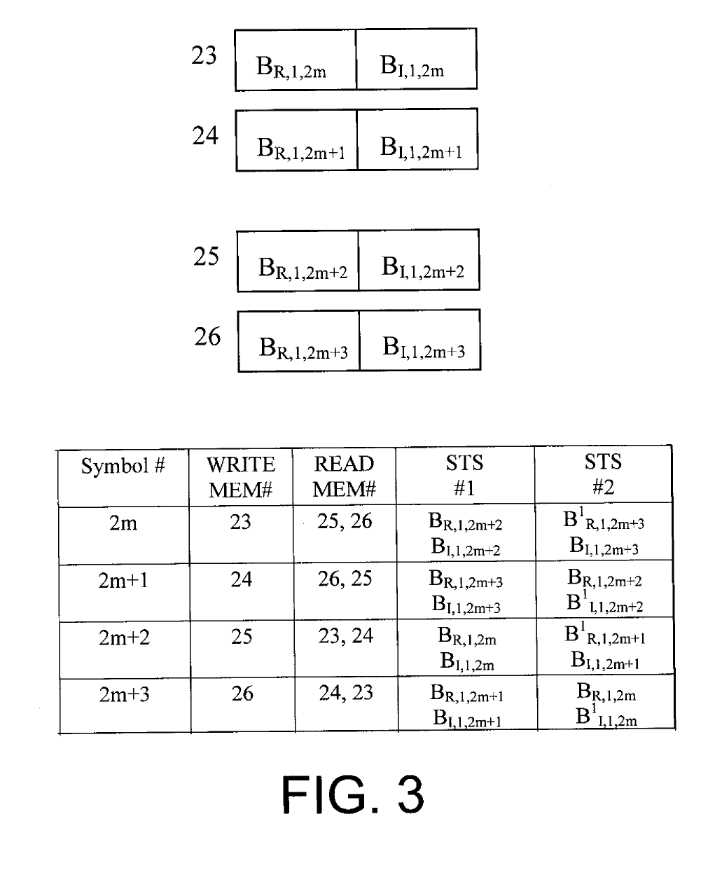

FIGS. 3-6 illustrate example pre-mapping STBC encoding operations for the STBC encoding options as described in the IEEE 802.11n Draft 2.0 specification, according to an example embodiment of the invention. FIG. 3 illustrates a example of pre-mapping STBC encoding with WRITE/READ memory operations in which N_{STS}=2 and N_{SS}=1. As shown in FIG. 3, there may be four memory locations 23-24 and 25-26 may be utilized where N_{STS}=2 and N_{SS}=1. Likewise, there may be two output channels STS #1 and STS #2. For example, as shown in FIG. 3, at a particular time, one memory location may be written to while two memory locations may be read from.

Referring to the example chart of FIG. 3, at a first time, input bits for symbol #2m may be written to memory location 23 while memory locations 25, 26 may be read from. STS #1 may then provide the bits (B_{R,I,2m+2} and B_{I,1,2m+2}) stored in memory location 25 for symbol 2m+2 while STS #2 may provide the bits (B¹_{R,I,2m+3} and B_{I,1,2m+3}) based on the bits stored in memory location 26 and bit-inverted accordingly for the negative complex conjugate of symbol 2m+3. Similarly, at a second time, input bits for symbol #2m+1 may be written to memory location 24 while memory locations 26, 25 may be read from. For example, STS #1 may then provide the bits (B_{R,I,2m+3} and B_{I,1,2m+3}) stored in memory location 26 for symbol 2m+3 while STS #2 may provide the bits (B_{R,I,2m+2} and B¹_{I,1,2m+2}) based on the bits stored in memory location 25 and bit-inverted accordingly for the complex conjugate of symbol 2m+2. At a third time, symbol #2m+2 may be written to memory location 25 while memory locations 23, 24 may be read from. STS #1 may then provide the bits (B_{R,I,2m} and B_{I,1,2m}) stored in memory location 23 for symbol 2m while STS #2 may provide the bits (B¹_{R,I,2m+1} and B_{I,1,2m+1}) based on the bits stored in memory location 24 and bit-inverted accordingly for the negative complex conjugate of symbol 2m+1. At a fourth time, symbol #2m+3 may be written to memory location 26 while memory locations 24, 23 may be read from. For example, STS #1 may then provide the bits (B_{R,I,2m+1} and B_{I,1,2m+1}) stored in memory location 24 for symbol 2m+1 while STS #2 may provide the bits (B_{R,I,2m} and B¹_{I,1,2m}) based on the bits stored in memory location 23 and bit-inverted accordingly for the complex conjugate of symbol 2m.

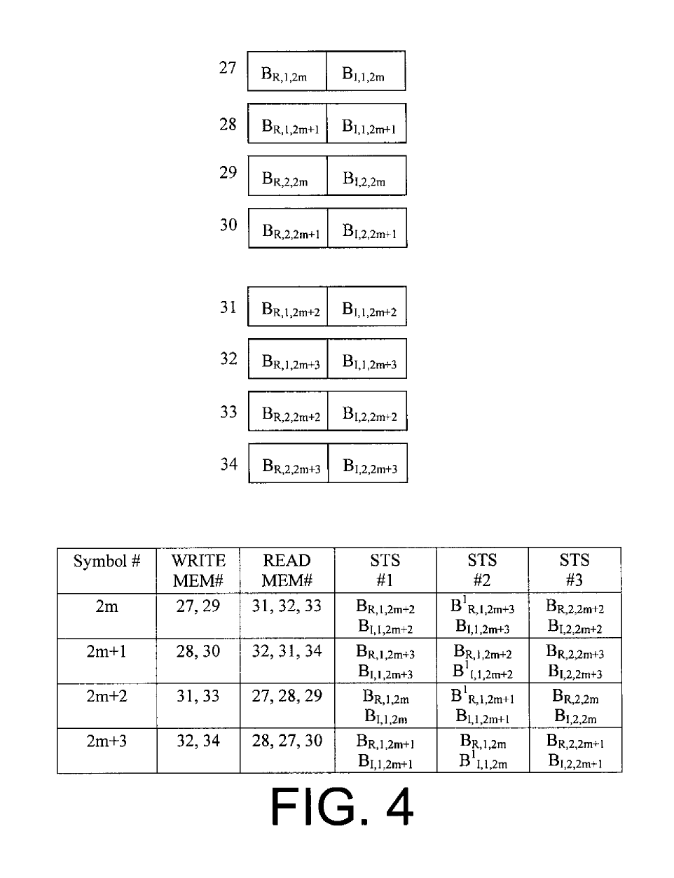

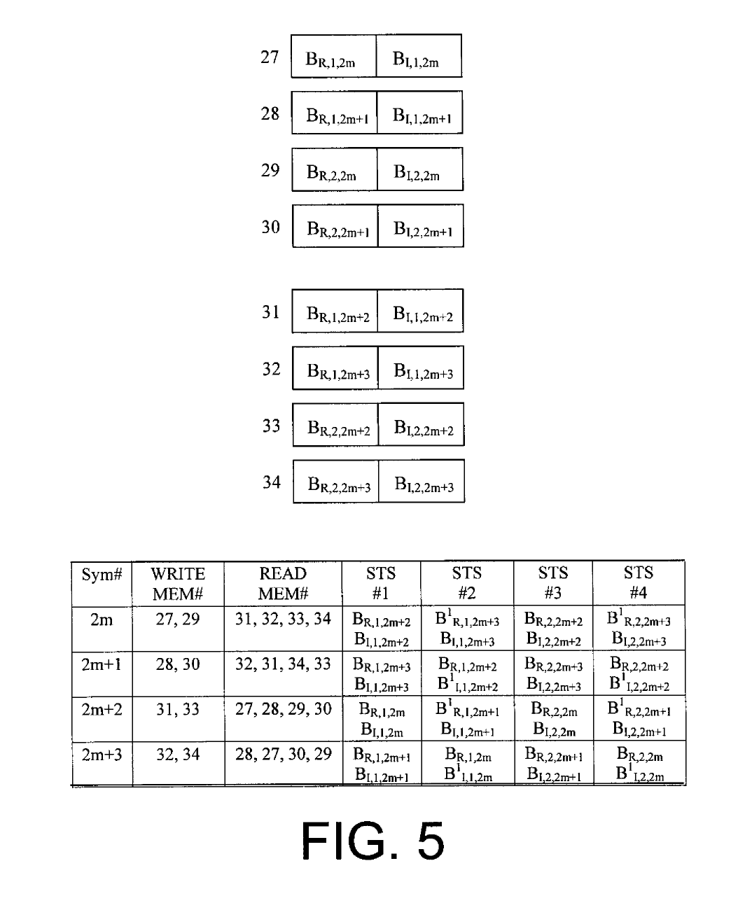

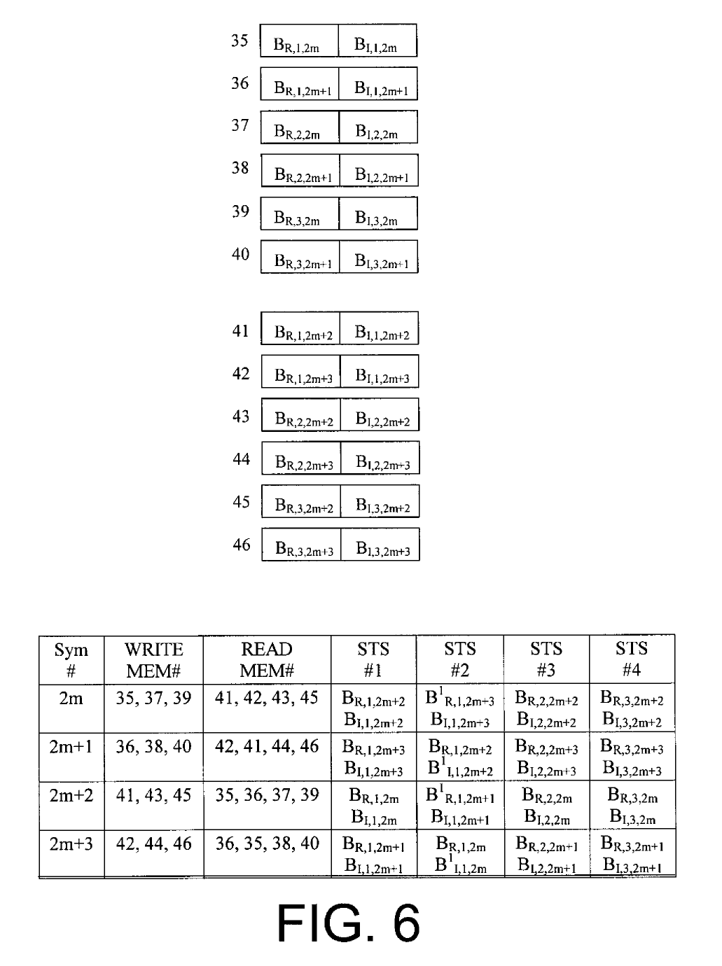

It will be appreciated that the example pre-mapping STBC encoding operations of FIG. 3 are illustrative and many variations are available such as those provided in FIGS. 4-6. For example, FIG. 4 illustrates an example pre-mapping STBC encoding with WRITE/READ memory operations in which N_{STS}=3 and N_{SS}=2, according to an example embodiment of the invention. In FIG. 4, eight memory locations 27-34 may be utilized for the pre-mapping STBC encoding. FIG. 5 illustrates an example pre-mapping STBC encoding with WRITE/READ memory operations in which N_{STS}=4 and N_{SS}=2. In FIG. 5, eight memory locations 27-34 may be utilized for the pre-mapping STBC encoding, according to an example embodiment of the invention. FIG. 6 illustrates an example pre-mapping STBC encoding with WRITE/READ memory operations in which N_{STS}=4 and N_{SS}=3. In FIG. 6, twelve memory locations 35-46 may be utilized for the pre-mapping STBC encoding, according to an example embodiment of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for supporting encoding of digital communications, comprising:
receiving at least one input bit, wherein the at least one input bit is associated with a mapping on a Gray-coded constellation map;
storing the received at least one input bit in one or more memory locations;
retrieving the at least one bit from the one or more memory locations; and
inverting a bit of the at least one bit to generate a conjugate of the at least one bit;
obtaining first coordinates of the conjugate according to the Gray-coded constellation map.

2. The method of claim 1, further comprising:
obtaining second coordinates of the at least one input bit according to the Gray-coded constellation map.

3. The method of claim 2, further comprising:
utilizing the first coordinates and the second coordinates for space time block coding (STBC).

4. The method of claim 1, wherein the Gray-coded constellation map is associated with one of Binary Phase Shift Keying (BPSK), Quadrature Phase-Shift Keying (QPSK), and Quadrature Amplitude Modulation (QAM).

5. The method of claim 4, wherein the QAM is 16-QAM, 64-QAM, 256-QAM, or 1024-QAM.

6. The method of claim 1, wherein inverting a bit of the at least one bit includes inverting a prefix bit of the at least one bit.

7. The method of claim 1, wherein the at least one bit includes a first set of bits and a second set of bits, the first set of bits associated with a first axis of the Gray-coded constellation map, and the second set of bits associated with a second axis of the Gray-coded constellation map.

8. The method of claim 7, wherein the conjugate includes a first conjugate and a second conjugate, and wherein inverting a bit includes:
inverting a first bit of the first set of bits to generate the first conjugate of the first set of bits; and
inverting a second bit of the second set of bits to generate the second conjugate of the second sets of bits.

9. The method of claim 1, wherein the Gray-coded constellation map is associated with reflect-and-prefix method.

10. The method of claim 1, wherein the at least one input bit is received from an interleaver.

11. A system for supporting encoding of digital communications, comprising:
at least one input bit, wherein the at least one input bit is associated with a mapping on a Gray-coded constellation map;
a write module for storing the at least one bit in one or more memory locations;
a read module for retrieving the at least one bit from the one or more memory locations;
a bit inverter module that inverts a bit of the at least one bit to generate a conjugate of the at least one bit;
a mapping module that obtains first coordinates of the conjugate according to the Gray-coded constellation map.

12. The system of claim 11, wherein the mapping module further obtains second coordinates of the at least one input bit according to the Gray-coded constellation map.

13. The system of claim 11, wherein the first coordinates and the second coordinates are utilized for space time block coding (STBC).

14. The system of claim 11, wherein the Gray-coded constellation map is associated with one of Binary Phase Shift Keying (BPSK), Quadrature Phase-Shift Keying (QPSK), and Quadrature Amplitude Modulation (QAM).

15. The system of claim 14, wherein the QAM is 16-QAM, 64-QAM, 256-QAM, or 1024-QAM.

16. The system of claim 11, wherein the bit inverter module inverts the bit of the at least one bit by inverting a prefix bit of the at least one bit.

17. The system of claim 11, wherein the at least one bit includes a first set of bits and a second set of bits, the first set of bits associated with a first axis of the Gray-coded constellation map, and the second set of bits associated with a second axis of the Gray-coded constellation map.

18. The system of claim 17, wherein the conjugate includes a first conjugate and a second conjugate, and wherein the bit inverter module inverting the bit includes the bit inverter module:
inverting a first bit of the first set of bits to generate the first conjugate of the first set of bits; and
inverting a second bit of the second set of bits to generate the second conjugate of the second sets of bits.

19. The system of claim 11, wherein the Gray-coded constellation map is associated with reflect-and-prefix method.

20. The system of claim 11, where the at least one input bit is received from an interleaver.
